(19) United States
(12) Patent Application Publication
(10) Pub. No.: US 2003/0128546 A1
(43) Pub. Date: Jul. 10, 2003

(54) Lamp having remote-control function

(76) Inventor: Ching Huei Chiou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/038,608

(22) Filed: Jan. 8, 2002

(51) Int. Cl. F21S 6/00

(52) U.S. Cl. 362/414; 362/802

(57) ABSTRACT

A lamp having remote-control function comprises a remote controller, a lamp, and a receiving module. The remote controller comprises a key, a light-emitting device, and a first control circuit. The first control circuit is connected to the key and the light-emitting device. When the key is pressed, the first control circuit generates an encoded signal, and the light-emitting device is conducted to emit out a signal. The lamp has at least a light bulb body. The receiving module is disposed in the lamp and connected to the light bulb body. The receiving module comprises a photoelectric device and a second control circuit. The photoelectric device receives the signal emitted by the light-emitting device, and the second control circuit generates a control signal to turn on, adjust and memorize the intensity of light, or momentarily or slowly turn off the light bulb body.

### FIELD OF THE INVENTION

The present invention relates to a lamp having remote-control function and, more particularly, to a lamp having an inbuilt control circuit and a remote controller matched with the control circuit so that the remote controller can remotely control the light bulb body to turn it on, to adjust and memorize the intensity of light, or to momentarily or slowly turn it off.

### BACKGROUND OF THE INVENTION

A prior art lamp 10a such as a floor lamp (as shown in FIG. 1) comprises a base 11a, a lamp stand 12a, and a lampshade 13a. The base 11a is a circular disk. The lamp stand 12a joins the base 11a. The lampshade 13a is disposed at the upper end of the lamp stand 12a, and projects upwards. A lamp socket 14a is disposed in the lampshade 13a. A light bulb 15a is disposed in the lamp socket 14a. When the lamp 10a is turned on, the light bulb 15a will projects out light to generate illumination effect.

However, the prior art lamp 10a has no remote-control function, and only monotonous effect of on or off state can be achieved for the control of the light bulb 15a. A user cannot adjust and memorize the intensity of light. Moreover, when the lamp is turned off momentarily, hazards usually occur due to unclear line of sight.

Accordingly, the above lamp has inconvenience and drawbacks in practical use. The present invention aims to resolve the problems in the prior art.

### SUMMARY OF THE INVENTION

The primary object of the present invention is to provide a lamp having a control circuit and a remote controller so that infrared signals of the remote controller can be used to remotely control the control circuit to vary and memorize the intensity of light of the lamp. Moreover, the functions of turning on the lamp and momentarily or slowly turning off the lamp can be achieved.

To achieve the above object, the present invention provides a lamp having remote-control function, which comprises a remote controller, a lamp, and a receiving module. The remote controller comprises a key, a light-emitting device, and a first control circuit. The light-emitting device is disposed on the remote controller, and can be an infrared light-emitting diode. The first control circuit is connected to the key and the light-emitting device, and is mainly used to generate encoded signals. The lamp has at least a light bulb body, which can be a halogen light bulb or an incandescent light bulb. The receiving module is disposed in the lamp, and is connected to the light bulb body. The receiving module comprises a photoelectric device and a second control circuit. The photoelectric device is disposed on a lamp stand of the lamp, and can be a photodiode. The second control circuit comprises a power supply unit, a discriminating unit, and a light bulb control unit, which are connected to each other. The power supply unit is used for rectification and regulation of voltage. The light bulb control unit is connected to the light bulb body via conducting wires. The discriminating unit is used to discriminate infrared signals received by the photodiode and to generate control signals, which are transferred to the light bulb control unit to control the light bulb body.

The various objects and advantages of the present invention will be more readily understood from the following detailed description when read in conjunction with the appended drawing, in which:

### BRIEF DESCRIPTION OF THE DRAWINGS

FIG. 1 is a perspective view of a prior art lamp;

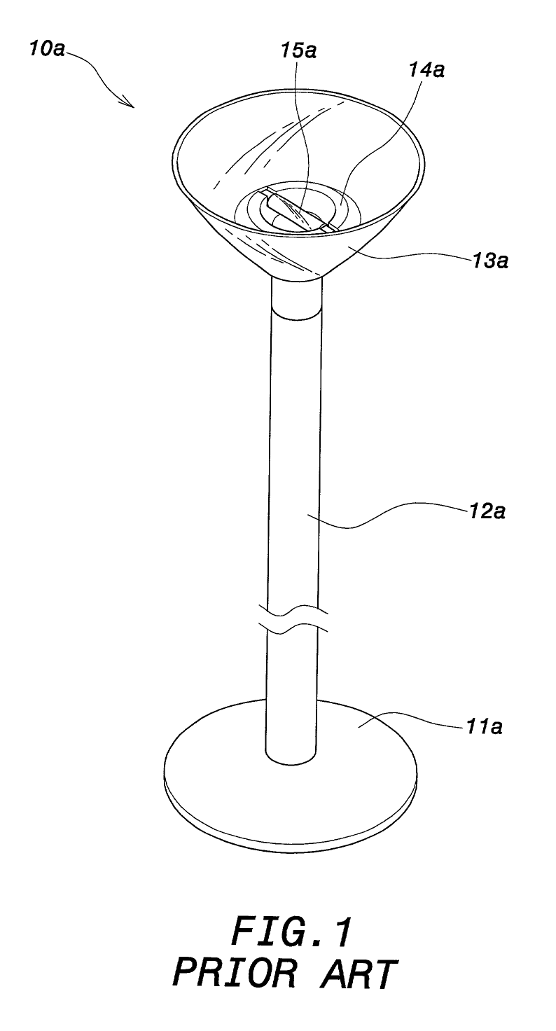

FIG. 2 is a perspective view of a remote controller of the present invention;

FIG. 3 is a circuit block diagram of a remote controller of the present invention;

FIG. 4 is a circuit diagram of a remote controller of the present invention;

FIG. 5 is a perspective view of a lamp of the present invention;

FIG. 6 is a circuit block diagram of a receiving module of the present invention;

FIG. 7 is a circuit diagram of a receiving module of the present invention;

FIG. 8 is a control flowchart of a light bulb of the present invention;

FIG. 9 is a perspective view of a lamp according to another embodiment of the present invention;

FIG. 10 is a circuit diagram of a receiving module according to another embodiment of the present invention;

FIG. 11 is a perspective view of the present invention wherein a light bulb body thereof is an incandescent light bulb; and

FIG. 12 is a perspective view of the present invention wherein the lamp is a table lamp.

### DETAILED DESCRIPTION OF THE PREFERRED EMBODIMENTS

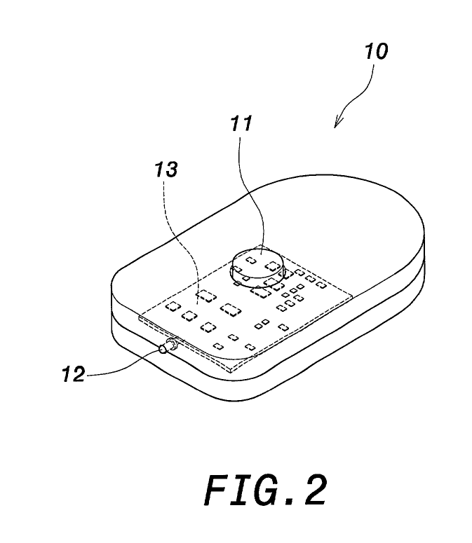

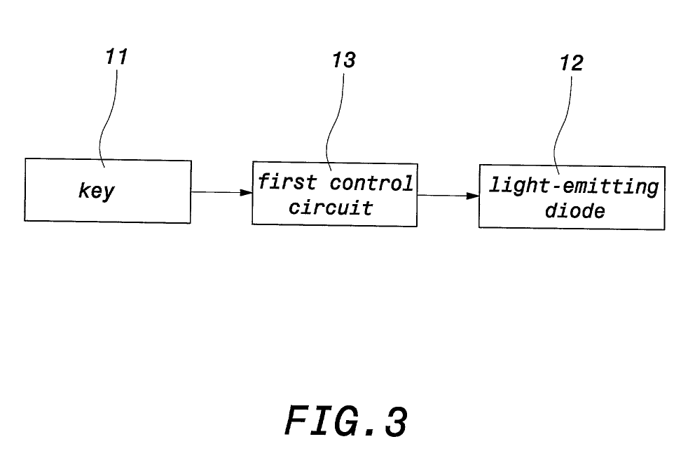

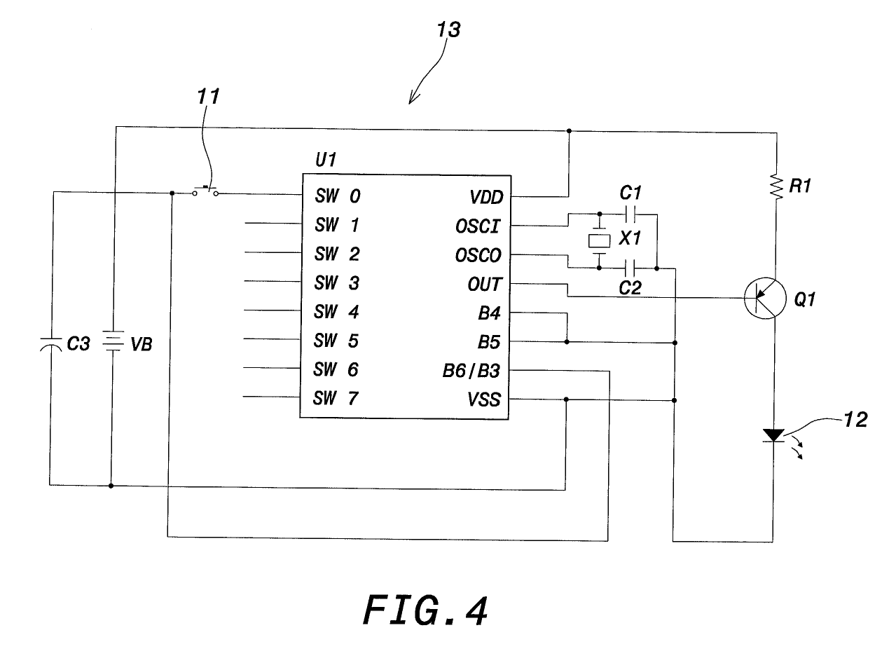

As shown in FIGS. 2 to 5, the present invention provides a lamp having remote-control function, which comprises a remote controller 10, a lamp 20, and a receiving module 30.

The remote controller 10 comprises a key 11, a light-emitting diode 12, and a first control circuit 13. The key 11 and the light-emitting diode 12 are disposed on the remote controller 10. The first control circuit 13 is connected to the key 11 and the light-emitting diode 12. The first control circuit 13 is formed by connecting a current-limiting resistor R1, capacitors C1, C2, and C3, a battery VB, a quartz oscillator X1, a transistor Q1, and a control chip U1. The capacitors C1 and C2 and the quartz oscillator X1 are modulated at 38 kHz. After the key 11 is pressed, the control chip U1 generates an 8-bit encoded signal and an 8-bit key code signal twice, and the transistor Q1 is conducted so that the light-emitting diode 12 can emit out an infrared signal.

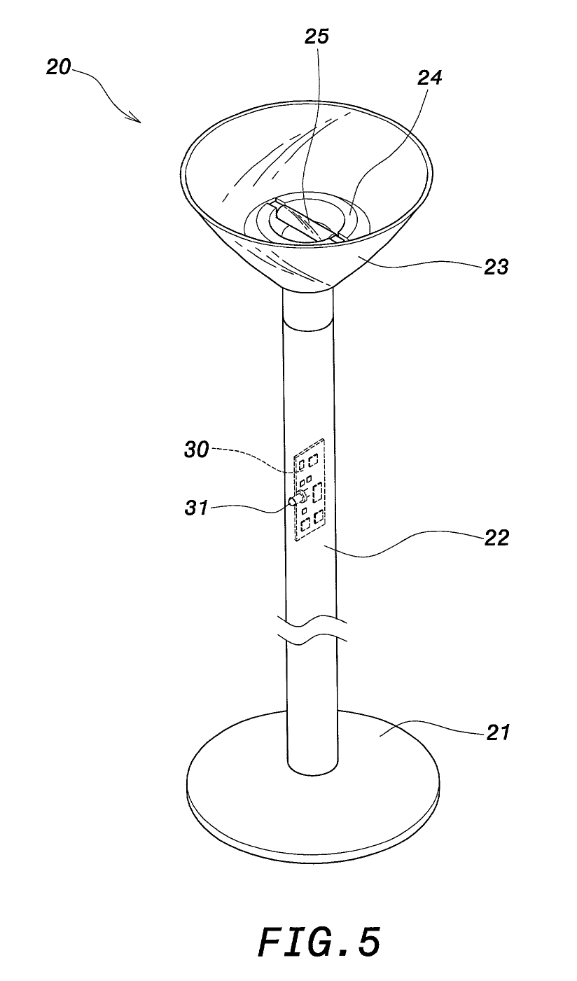

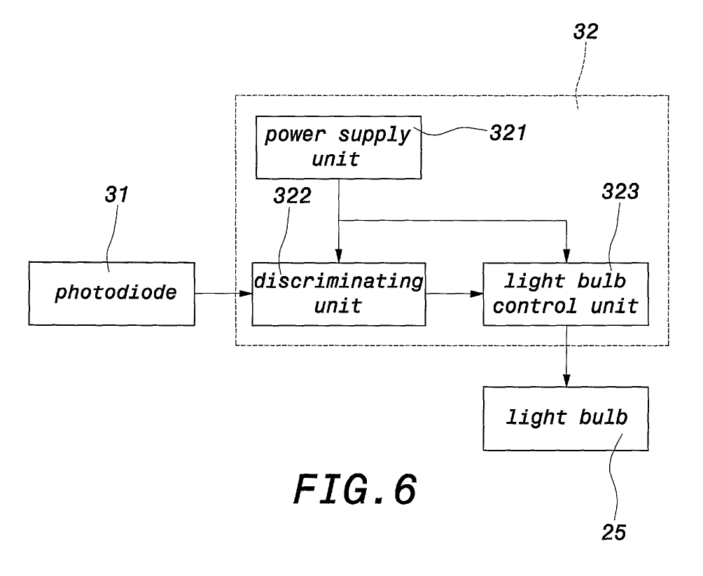

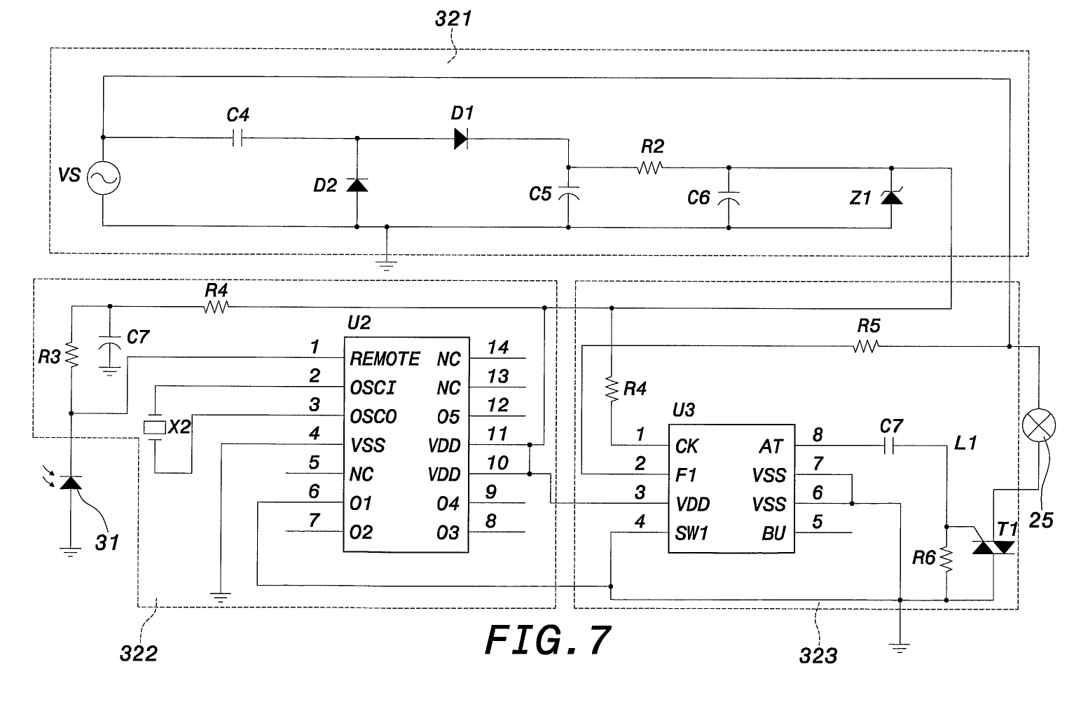

As shown in FIGS. 5 to 7, the lamp 20 (a floor lamp in this embodiment) comprises a base 21, a lamp stand 22, and a lampshade 23. The base 21 is a circular disk. The lamp stand 22 joins the base 21. The lampshade 23 is disposed at the upper end of the lamp stand 22, and projects upwards. A lamp socket 24 is disposed in the lampshade 23. A light bulb body 25 is disposed in the lamp socket 24. The light bulb body 25 is a halogen light bulb.

The receiving module 30 is disposed in the lamp stand 22, and is connected to the light bulb body 25 via conducting wires (not shown). The receiving module 30 is formed by connecting a photodiode 31 and a second control circuit 32. The photodiode 31 is disposed on the lamp stand 22, and is used to receive infrared signals emitted by the light-emitting diode 12 of the remote controller 10. The second control circuit 32 comprises a power supply unit 321, a discriminating unit 322, and a light bulb control unit 323.

The power supply unit 321 is formed by connecting a resistor R2, capacitors C4, C5, and C6, diodes D1 and D2, an AC power source Vs, and a Zener diode Z1. The power supply unit 321 is used for rectification and regulation of voltage of an AC power source of 120V to supply a DC voltage of 5V.

The discriminating unit 322 is connected to the power supply unit 321 and the photodiode 31, and is formed by connecting resistors R3 and R4, a capacitor C7, a quartz oscillator X2, and a control chip U2. After the photodiode 31 receives an infrared signal emitted by the light-emitting diode 12, the discriminating unit 322 will remove the 38 kHz modulated signal and then decode and discriminate the signal. If the signal is correct, a key code signal thereof will be transferred to the control chip U2 so that the control chip U2 can send out a control signal at corresponding output pins.

The light bulb control unit 323 is connected to the power supply unit 321, the discriminating unit 322, and the light bulb body 25, and is formed by connecting resistors R4, R5, and R6, a capacitor C7, a triode (silicon-controlled rectifier) T1, and a control chip U3. The control signal is transferred to the control chip U3 so that the control chip U3 can generate a signal of turning on, adjusting the intensity of light, or momentarily or slowly turning off to control the light bulb body 25.

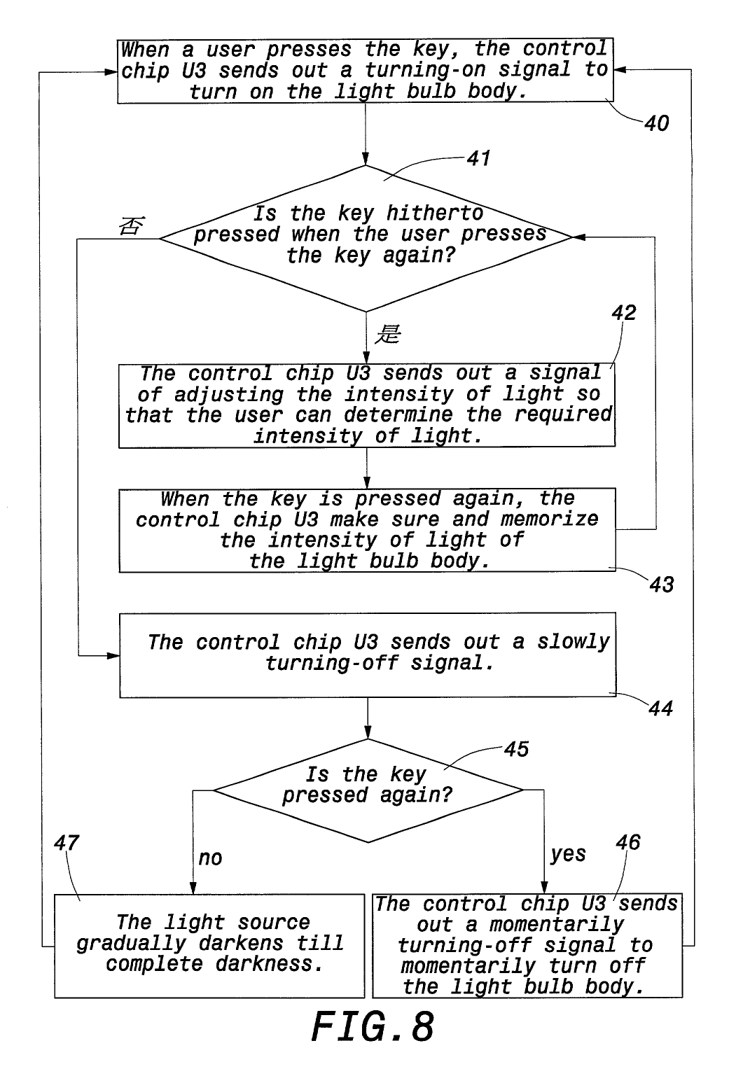

The lamp 20 can thus achieve remote-control function using the remote controller 10. FIG. 8 shows a control flowchart of the light bulb body 15 of the present invention. The flowchart comprises the following steps.

Step 40: When a user presses the key, the control chip U3 sends out a turning-on signal to turn on the light bulb body;

Step 41: When the user presses again, the control chip U3 judges whether the key is hitherto pressed. If the answer is negative, step 44 is jumped to;

Step 42: The control chip U3 sends out a signal of adjusting the intensity of light so that the user can determine the required intensity of light;

Step 43: When the key is pressed again, the control chip U3 make sure the intensity of light of the light bulb body and memorize it, and step 41 is then jumped back to;

Step 44: The control chip U3 sends out a slowly turning-off signal;

Step 45: Whether the user presses the key again is judged. If the answer is negative, step 47 is jumped to;

Step 46: The control chip U3 sends out a momentarily turning-off signal to momentarily turn off the light bulb body, and then step 40 is jumped back to;

Step 47: The light source gradually darkens to prevent hazards from occurring due to unclear line of sight for the user.

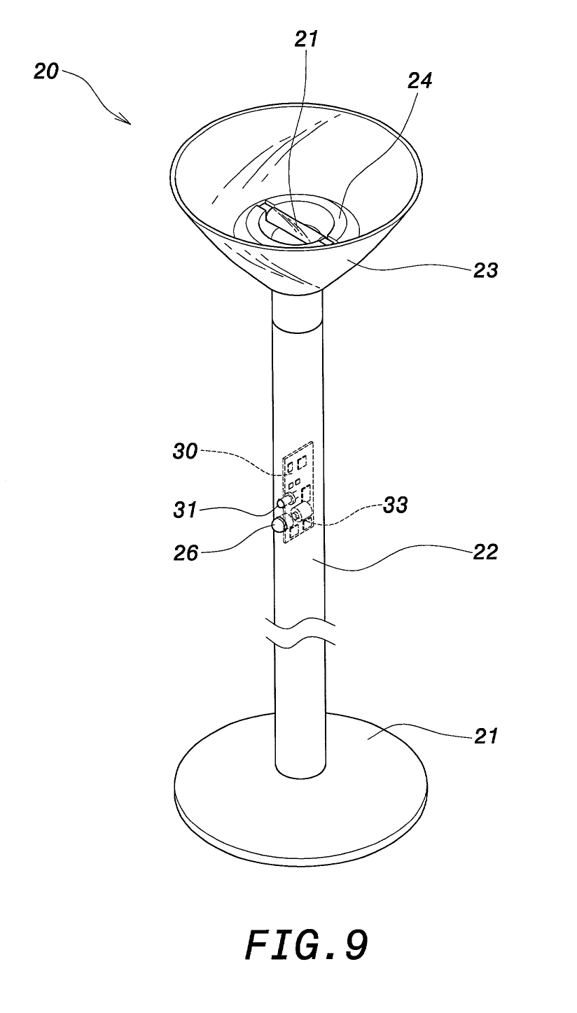

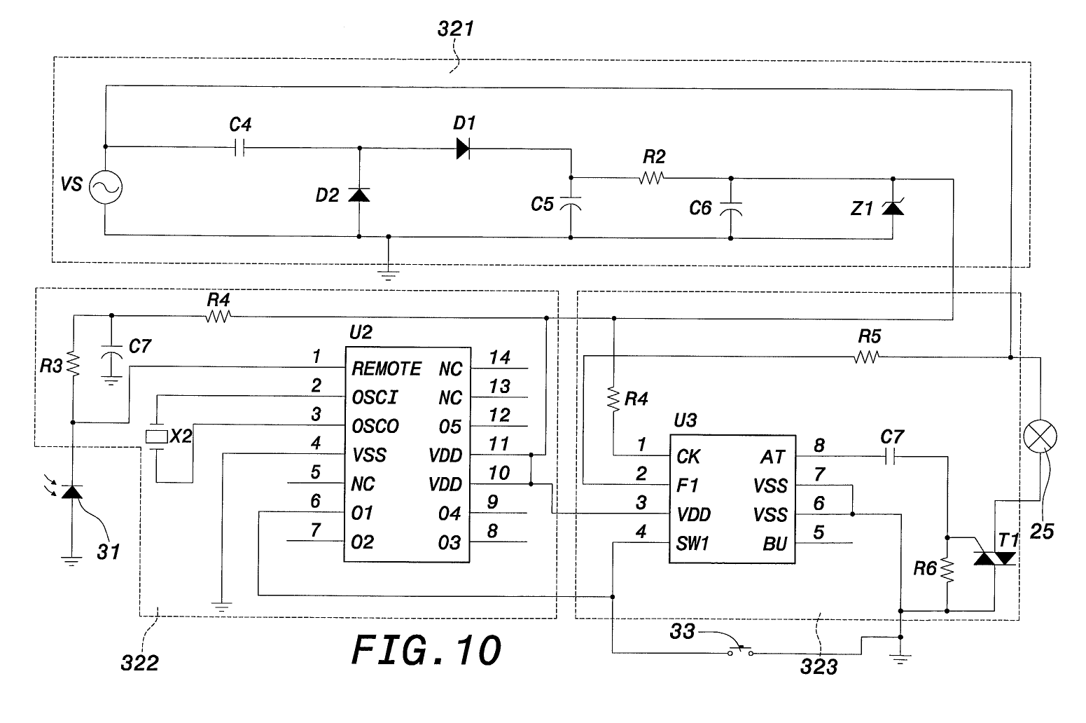

As shown in FIGS. 9 and 10, a switch 33 can also be attached on the second control circuit 32, and a mobile screw nut 26 can be screwed on the lamp stand 22 and near the switch 32. When the mobile screw nut 26 is pressed, the switch 26 is driven so that a user can directly control the light bulb body 25 on the lamp 20.

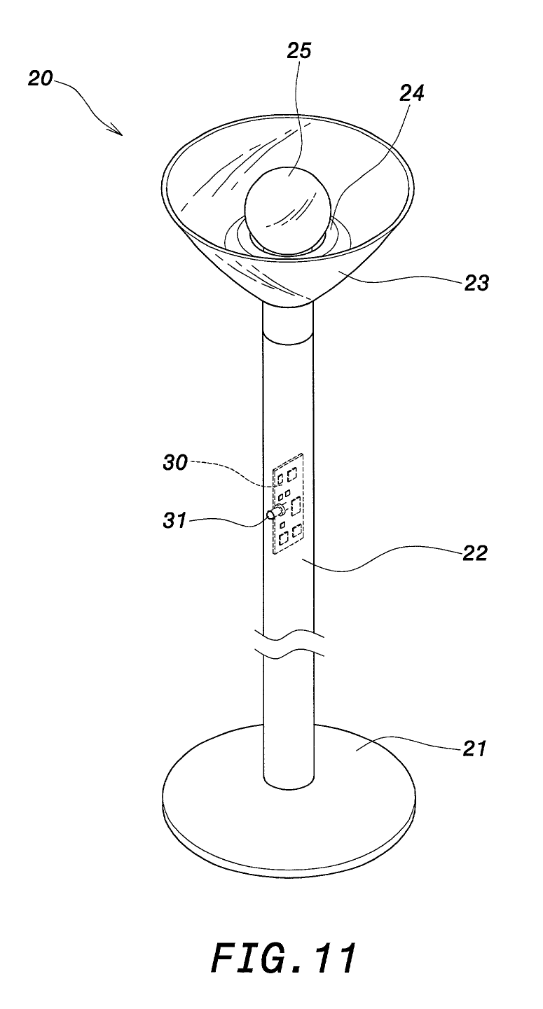

As shown in FIG. 11, the light bulb body 25 can be an incandescent light bulb.

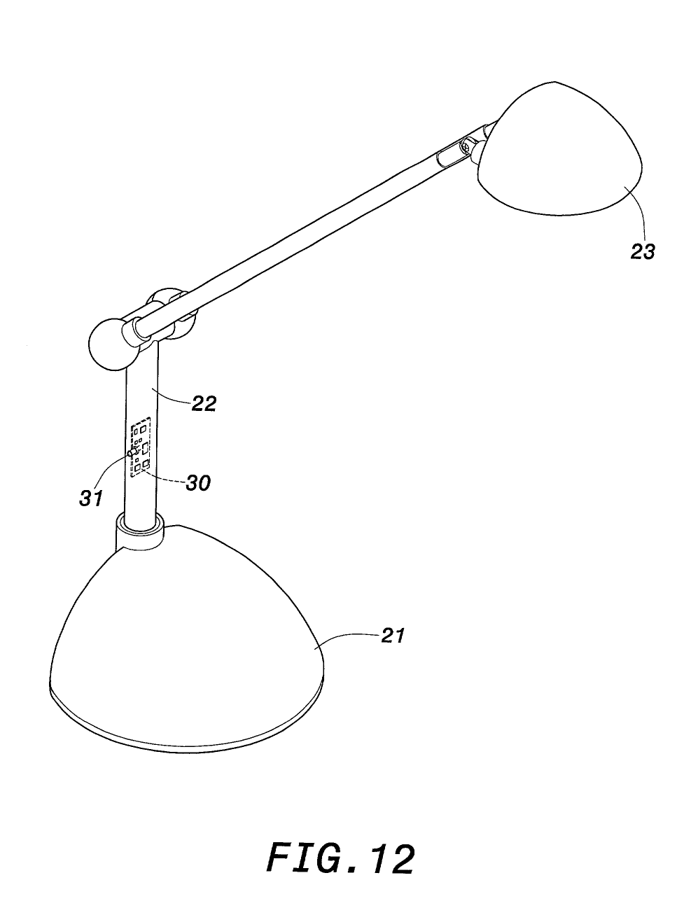

As shown in FIG. 12, the lamp 20 can be a table lamp.

To sum up, the present invention has the following characteristics.

(1). The lamp can be remotely controlled using infrared rays.

(2). The intensity of light of the light bulb body can be set and memorized.

(3). The function of slowing turning off the lamp can be achieved.

(4). In addition to remote control, the mobile screw nut can be directly pressed on the lamp to control the light bulb body.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A lamp having remote-control function, comprising:
a remote controller comprising a key, a light-emitting device, and a first control circuit, said first control circuit being connected to said key and said light emitting device, said first control circuit being enabled to generate encoded signals when said key is pressed so that said light-emitting device can be conducted to emit out a signal of light source;
a lamp having at least a light bulb body; and
a receiving module disposed in said lamp and connected to said light bulb body, said receiving module comprising a photoelectric device and a second control circuit, said photoelectric device being used to receive said signal of light source emitted by said light-emitting device of said remote controller, said signal of light source being decoded by said second control circuit, which then sends out a control signal to control said light bulb body.

2. The lamp having remote-control function as claimed in claim 1, wherein said light-emitting device is disposed on said remote controller.

3. The lamp having remote-control function as claimed in claim 1, wherein said light-emitting device is an infrared light-emitting diode.

4. The lamp having remote-control function as claimed in claim 1, wherein said light bulb body is a halogen light bulb or an incandescent light bulb.

5. The lamp having remote-control function as claimed in claim 1, wherein said photoelectric device is disposed on said lamp.

6. The lamp having remote-control function as claimed in claim 1, wherein said photoelectric device is a photodiode.

7. The lamp having remote-control function as claimed in claim 1, wherein said second control circuit comprises:
a power supply unit for rectification and regulation of voltage;
a discriminating unit connected to said power supply unit and said photoelectric device, said discriminating unit being used to receive and discriminate said infrared signal of light source emitted by said light-emitting device, and then send out a control signal; and
a light bulb control unit connected to said power supply unit, said discriminating unit, and said light bulb body, said light bulb control unit being controlled by said control signal transferred by said discriminating unit to turn on said light bulb body, adjust and memorize the intensity of light of said light bulb body, or momentarily or slowly turn off said light bulb body.

8. The lamp having remote-control function as claimed in claim 1, wherein a switch can be attached on said second control circuit, and a mobile screw nut can be screwed to said lamp to drive said switch.
